(19) United States
(12) Patent Application Publication
(10) Pub. No.: US 2009/0212103 A1
(43) Pub. Date: Aug. 27, 2009

(54) Floor Machine and Surface Cleaning Within a Field of RFID Tags

(76) Inventors: Eric C. Li, Minneapolis, MN (US); Robert J. Erko, Apple Valley, MN (US)

Correspondence Address: BRIGGS AND MORGAN P.A., 2200 IDS CENTER, 80 SOUTH 8TH ST, MINNEAPOLIS, MN, 55402, US

(21) Appl. No.: 12/364,345

(22) Filed: Feb. 2, 2009

Related U.S. Application Data
(60) Provisional application No. 61/025,484, filed on Feb. 1, 2008.

(51) Int. Cl. G06F 17/00; H04Q 5/22

(52) U.S. Cl. 235/375; 340/10.1

(57) ABSTRACT

A machine and method of use for cleaning a floor surface by traversing the floor field with a floor cleaning machine having an RFID system and accessing a plurality of RFID tags within the floor field to determine a position of the cleaning machine within the floor field during a cleaning session. An electronic map may be generated by and/or stored on the floor cleaning machine or may be remotely accessed during the floor cleaning session. A variety of information relating to machine operation characteristics and/or performance can be collected during the cleaning session in combination with machine location information from the RFID system.

### RELATED APPLICATIONS

This application claims the benefit of priority of U.S. Ser. No. 61/025,484, filed Feb. 1, 2008, which is hereby incorporated by reference in its entirety.

### TECHNICAL FIELD

The present invention relates generally to machine localization. More particularly, the invention relates to techniques and devices for portable floor cleaning machine localization based on signals received from one or more radio frequency tags dispersed throughout a floor field within which the portable floor cleaning machine is functioning.

### BACKGROUND OF THE INVENTION

Radio frequency identification (RFID) systems have been employed in an ever increasing range of applications. For example, RFID systems have been used in supply chain management applications to identify and track merchandise throughout manufacture, warehouse storage, transportation, distribution, and retail sale. RFID systems have also been used in security F applications to identify and track personnel for controlling access to restricted areas of buildings and plant facilities, thereby prohibiting access to such areas by individuals without the required authorization. Accordingly, RFID systems have been increasingly employed in diverse applications to facilitate the identification and tracking of merchandise, personnel, and other items and/or individuals that need to be reliably monitored and/or controlled within a particular environment.

A conventional RFID system typically includes at least one RFID transponder or tag, at least one RFID reader, and at least one controller or host computer. For example, in a manufacturing environment, RFID tags can be attached to selected items of manufacture or equipment, and at least one RFID reader can be deployed in the environment to interrogate the tags as the tagged items pass predefined points on the manufacturing floor. In a typical mode of operation, the reader transmits a radio frequency (RF) signal in the direction of a tag, which responds to the transmitted RF signal with another RF signal containing information identifying the item to which the tag is attached, and possibly other data acquired during the manufacture of the item.

Whether implemented as computer peripherals or networked devices, conventional RFID readers generally collect data from RFID tags much like optical barcode readers collect data from barcode labels. However, whereas an optical barcode reader typically requires a direct line of sight to a barcode label to read the data imprinted on the label, the RF signals employed by the typical RFID reader can penetrate through objects obstructing an RFID tag from the RF field of view of the reader, thereby allowing the reader to access data from a tag that, for example, might be covered. In addition, unlike the optical barcode reader, the conventional RFID reader can operate on and distinguish between multiple RFID tags within the field of the reader.

### BRIEF SUMMARY OF THE INVENTION

A system of floor machine localization according to an aspect of the present invention employs a set of radio frequency identification tags (RFID) dispersed throughout a floor field. In one example, location of a portable floor maintenance machine within a field of RFID tags is determined by receiving and processing signals received from RFID tags in the vicinity of the machine. Signals from multiple tags can be employed in determining the location. Depending on the particular tags employed, floor machine localization may be accomplished by associating locations with specific codes or by associating locations with possible paths that may be used to reach the locations.

Another aspect of the present invention relates to a method of operating a floor cleaning machine within a flooring field having a plurality of RFID tags wherein during a floor cleaning session the machine detects nearby RFID tags and provides a collection or report of the cleaning process based on the detected RFID tags. For example, the floor cleaning machine could determine the size of the area cleaned, machine/operator efficiency, etc.

According to an embodiment of the present invention, a computer-implemented method for object localization comprises providing a plurality of tags having known or determinable positions within an environment, and providing a reader or plurality of readers, for detecting the tags and reading tag identifications.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a perspective view a floor cleaning machine traversing a floor field having a plurality of RFID tags incorporated within a plurality of floor tiles in accordance to the present invention.

FIG. 2 illustrates aspects of an embodiment of a localization procedure in accordance with the present invention.

FIG. 3 illustrates aspects of another embodiment of a localization procedure in accordance with the present invention.

FIG. 4 illustrates aspects of another embodiment of a localization procedure in accordance with the present invention.

FIG. 5 illustrates a graphical report of a cleaning session utilizing aspects of a localization procedure in accordance with the present invention.

### DETAILED DESCRIPTION OF THE INVENTION

Significant customer value can be derived if a portable floor maintenance machine's location can be accurately determined within a building or other site. An embodiment of the present invention provides a system for locating a portable floor maintenance machine within a field of RFID tags. In one embodiment, the portable machine performs a floor cleaning function such as sweeping, scrubbing or both.

By way of background, in the conventional RFID system, each RFID tag typically includes a small antenna operatively connected to a microchip. For example, in the UHF band, the tag antenna can be just several inches long and can be implemented with conductive ink or etched in thin metal foil on a substrate of the microchip. Further, each tag can be an active tag powered by a durable power source such as an internal battery, or a passive tag powered by inductive coupling, receiving induced power from RF signals transmitted by an RFID reader. For example, an RFID reader may transmit a continuous unmodulated RE signal (i.e., a continuous wave, CW) or carrier signal for a predetermined minimum period of time to power a passive tag. The volume of space within which a reader can deliver adequate power to a passive tag is known as the power coupling zone of the reader. The internal battery of active tags may be employed to power integrated environmental sensors, and to maintain data and state information dynamically in an embedded memory of the tag. Because passive tags do not have a durable power source, they do not include active semiconductor circuitry and must therefore maintain data and state information statically within its embedded memory.

The REID reader typically follows a predefined sequence or protocol to interrogate and retrieve data from one or more RFID tags within the RF field of the reader (also known as the interrogation zone of the reader). It is noted that the interrogation zone of a reader is generally determined by the physical positioning and orientation of the reader relative to the tags, and the setting of various parameters (e.g., the transmit power) employed by the reader during the interrogation sequence.

During the typical interrogation sequence described above, the reader may be tuned to detect changes in the small signals reflected from the antennae of the passive tags, or to receive the responses generated and transmitted by the active tags.

In preferred forms the invention provides a mobile floor cleaning device that transmits a low-power radio frequency (“RF”) signal and that has the ability to receive digital RF signals back from passive RFID tags. Intelligent, passive (no-power) RFID tags intercept the mobile cleaning device's RF signal and use the RF signal to power the RFID tag and then transmit an intelligent-digital RF signal back to the mobile cleaning device, informing the cleaning device of the presence of the RFID tag and what kind of RFID tag. The cleaning device has a controller with a processor having a software algorithm to interpret the digital data.

The RFID tag is preferably of the passive type, meaning that it does not transmit a signal on its own absent external stimulation. The RFID tag may thus only transmit a signal to the mobile cleaning device when the cleaning device is sufficiently near the tag and the cleaning device's RF energy has intercepted the tag.

In one form, the method of powering the RFID tags is by induction coupling, although other techniques such as propagating electromagnetic waves can be used. The RF signal from the RFID tag is a carrier signal that is transmitting an intelligent digital signal.

In order to determine the position of a cleaning machine within a facility or site, a detailed map of the facility can be created. In known autonomous machine deployment approaches, mapping has included a dedicated mapping device and reference to detailed drawings of the facility.

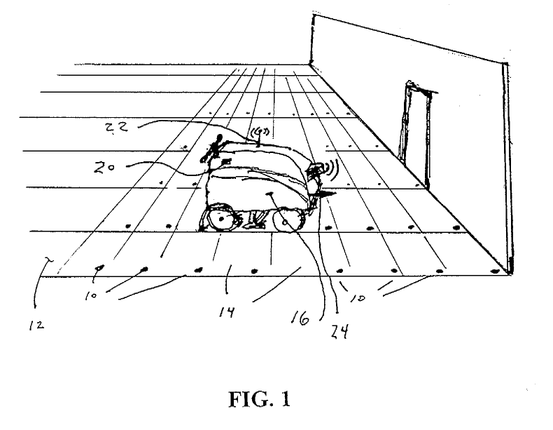

Referring to FIG. 1, a plurality of RFID tags 10 can be dispersed within a floor field 12. In one example, tags 10 are incorporated into or secured to carpet tiles 14. In one embodiment, the tags 10 are placed in a regular pattern upon the floor field 12. During machine 16 operation, tag placement information can be determined via an electronic reader 24 and control system 20. Control system 20 may communicate via antenna 22 to a remote system for remote generation of a facility map. Map information can be transferred using a data cell phone connection to a file site on the Internet. RFID tags 10 can be placed within the floor field 12 in many different ways. For example, RFID tags 10 can be integrated in labels or stickers which are secured to carpet tiles. The RFID tags can be adhered directly to the floor surface. According to another example, RFID tags can be embedded in carpet or hardwood floors.

Once the RFID tags 10 are placed on the floor field 12, an electronic map can be created. One novel approach to map generation is disclosed in applicant's U.S. Ser. No. 61/025,413, entitled “Passive Mapping Using a Cleaning Machine” and incorporated herein by reference. Once a map has been created, the location of machine 16 can be determined during machine operation. This can be done by using a localization system along with a tag reader on the cleaning machine. Given the known placement of the RFID tags in an environment, and the shape of the scan volume of the tag reader, certain information about the location of the tag reader in the environment can be determined. This determination may be geometrical and can be extended with time information.

Referring again to FIG. 1, in one example scenario, assume that in an indoor environment, a regular grid of passive RFID tags has been placed on the floor. Further, assume that the locations of these tags are known to a desired precision. Each RFID tag has a unique ID. Given the known shape of the scanning volume, the location of the machine 16 can be determined with respect to a coordinate system of which the positions of the passive RFID tags are known. The scanning volume and its intersection with the grid on which the RFID tags lie, as shown in FIG. 1, can yield orientation information to a certain accuracy. The shape of the scanning volume can be used in localization. Similar to the surface shape of the RFID tags, the shape of the scan volume limits the amount of the localization information that can be recovered.

Given that the positions of the RFID tags in the environment are known, the shape of the scanning volume is used to determine the location of the tag reader. The level of localization information obtainable from the tag reader will be determined by the shape of the scan volume as well as tag characteristics and tag placements. Using this information, the position and orientation of the cleaning machine 16 can be determined.

Localization in larger environments, such as within a factory or an office building, can be used in, for example, delivery of consumables, security and access control. Further uses may include data caching based on the location when storage and bandwidth limit the amount of data that can be stored.

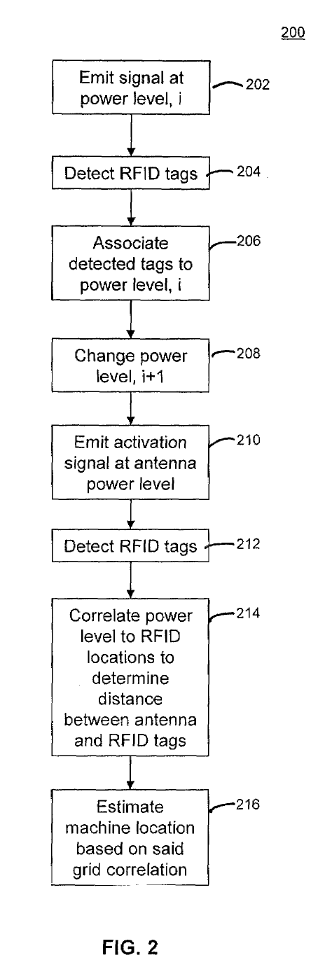

FIG. 2 illustrates an approach to machine 16 localization. The process identified in FIG. 2 may be handled by a controller on machine 16 alone or in combination with a remote server or other controller. In this example, RFID signal strength is utilized as an indicator of the distance between machine 16 and RFID tags 10. When the RFID antenna emits a signal, any RFID tags within the field are triggered and transmit a return signal to the RFID reader. The size of the field of view emitted from the antenna can be varied by changing the power level supplied to the antenna at which RFID tags 10 come into view, and the approximate distance between the antenna and the tags can be estimated to yield machine 16 location. As machine 16 traverses floor field 12, at step 202 an interrogation or other activation/identification signal is emitted at a predetermined power level, i. At step 204, certain RFID tags within field 12 are identified. Power level, i, is associated with the identified tags at step 206. At step 208, the interrogation/activation signal power level is increased (or decreased) and emitted at step 210. Additional RFID tags are detected at step 212. At step 214, distances between machine 16 and various RFID tags are determined by correlating power levels to RFID locations. Machine 16 location can be determined at step 216 based on distance information determined in step 214.

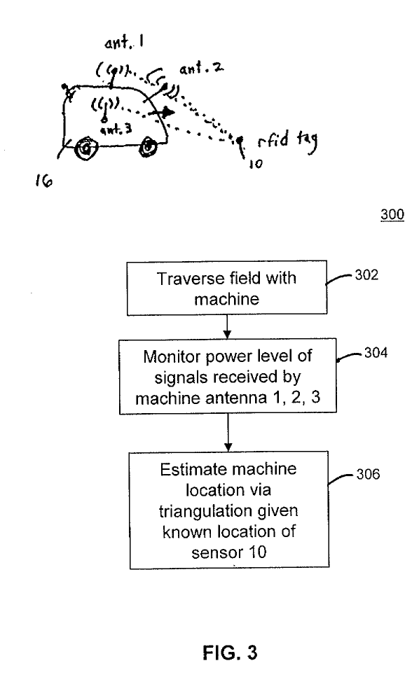

FIG. 3 illustrates another approach to machine 16 localization. If three or more antennas are included in the RFID system of machine 16, each RFID tag 10 can be detected by each antenna. By monitoring the power level of the signals supplied to the antenna at which the RFID tags 10 come into view, the approximate distance between each antenna and the tags 10 can be estimated. These distances can be used to triangulate the location of the tag 10 in two dimensions. By way of example, machine 16 traverses a floor field during a cleaning operation at step 302. At step 304, machine 16 monitors power levels of signals received by antenna 1, antenna 2 and antenna 3 as machine 16 traverses the floor field. At step 306, machine 16 estimates its location via triangulation given the distance to tag 10.

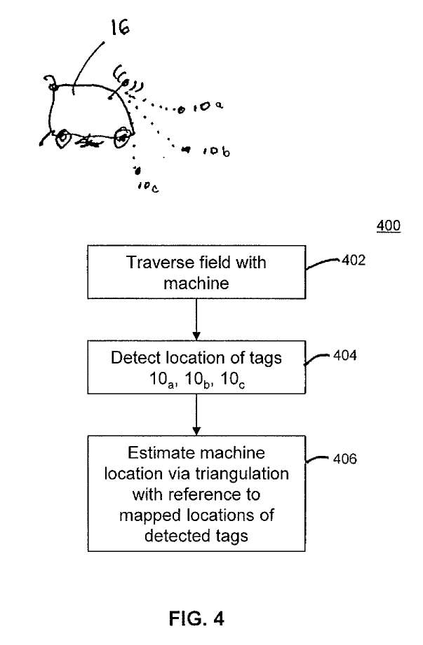

FIG. 4 illustrates yet another approach to machine 16 localization. If multiple tags 10 are accessible to an antenna, and assuming the location of the tags 10 is known from a map, the distance of the tags 10 to the machine 10 can be determined, for example, from the power of the signal required to trigger the tags 10. The position of the machine 16 can be triangulated using three or more tags as accessed by the reader. By way of example, machine 16 traverses a floor field during a cleaning operation at step 402. At step 404, machine 16 monitors power levels of signals received from tags 10a, 10b and 10c as machine 16 traverses the floor field. At step 406, machine 16 estimates its location via triangulation given the distance to tags 10a-c.

In yet another approach to machine localization, the size of the field of view can be affected by environmental sources such as the presence of metal or liquids on the floor. Since the operating environment may vary, the size of the field of view also changes if the power level of the signal form the antenna is constant. In order to detect the change of the field of view, a sequence of motion can be executed on the autonomous machine. The motion is required to move the field of view of the antenna over one or more reference tags multiple times at a known speed. As the tag 10 enters and exits the field of view, the size of the field of view can be determined using speed of the moving field and the duration of the tag presence in the field.

In another example of the present invention, a floor maintenance machine incorporating an RFID reader may be operated on a floor surface containing a plurality of RFID tags dispersed throughout a floor field. As the floor maintenance machine traverses the floor field during a cleaning process, the RFID reader detects those RFID tags in proximity to the floor maintenance machine. For example, if the floor maintenance machine is a vacuum cleaner, it would be desirable to identify the RFID tags passing underneath the vacuum cleaner. In this manner, a collection of RFID tag information may be created to signify the region or area across which the vacuum cleaner traversed during the cleaning session. In some embodiments, an electronic floor map may not be needed. In other embodiments, it may be desirable to access a partial floor map. If only the total number of RFID tags dispersed within a floor field is known, it may be desirable to provide simply a number of RFID tags detected or the percentage of RFID tags detected during the cleaning session. In some applications, only the total number of RFID tags may be known or be calculable based, for example, on the square footage of flooring, e.g., carpet. For example, a carpeted space may contain 1 RFID tag per square yard of carpet. An RFID system of the present invention may simply count the number of RFID tags detected during the cleaning session and provide an indication to the user of the number of square yards of carpet that was cleaned during the session.

In another example of the present invention, a floor maintenance machine may incorporate an RFID reader that detects RFID tags passing underneath the machine and a controller (which may be incorporated within RFID reader) detects overall machine operating status. For example, the RFID tag reader collects information relating to RFID tags passing underneath a vacuum cleaner and the machine controller collects information relating to vacuum system status. The machine could present the operator with a report relating to machine efficiency, operating characteristics, etc. As an example of machine efficiency, the system may determine whether the vacuum machine repeatedly traverses the same area within the floor field during the cleaning session. In one example, a graphical report may be generated on the machine (or remotely) that illustrates the regions within the floor field that have been covered (or missed) during the cleaning session.

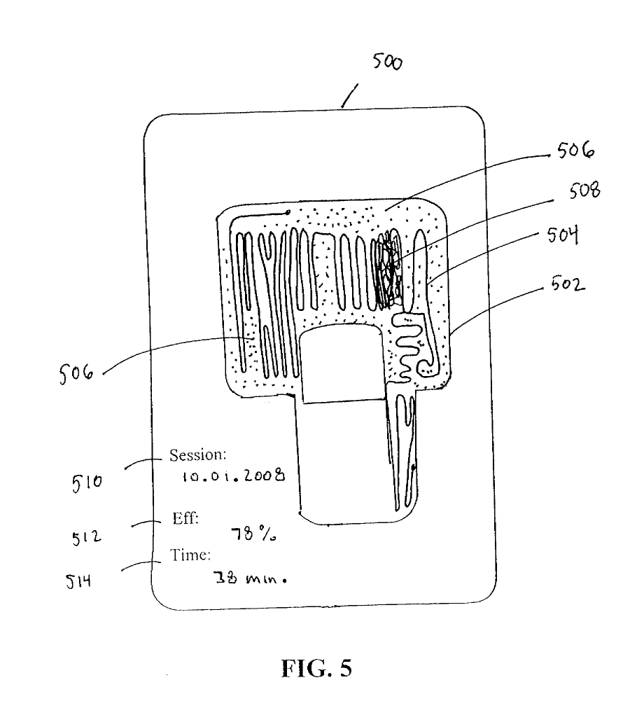

FIG. 5 illustrates a graphical report 500 including an outline of an area to be cleaned 502. A line 504 depicts the movement of a cleaning machine within the area to be cleaned 502. The cleaning machine may be a vacuum-based sweeper operating in an industrial or commercial facility. The machine travel path information is generated by an RFID system which detects and stores the location of the cleaning machine within the facility as described above. Numeral 506 depicts regions within the area to be cleaned 502 that were missed during the cleaning session. Numeral 508 depicts a region possibly indicative of inefficient machine use (cleaning machine path overlaps). Report 500 may include session identification 510, session efficiency 512 and session time (elapsed) 514.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A floor cleaning machine operating in a region of RFID tags comprising:
a floor maintenance tool carried by the floor cleaning machine, said floor maintenance tool performing a floor cleaning task as the floor cleaning machine traverses the region; and
an REID system including an REID reader accessing one or more of a plurality of RFID tags distributed throughout the region as the floor cleaning machine traverses the region during a cleaning session.

2. The floor cleaning machine of claim 1, wherein the RFID system includes RF information for each RFID tag from which a signal is received or signal strength of signals or both.

3. The floor cleaning machine of claim 2, wherein the RF information received from one or more tags includes unique tag identification information.

4. The floor cleaning machine of claim 3, wherein the plurality of RFID tags is regularly distributed throughout the region, and each of the tags emitting a signal including tag identification information.

5. The floor cleaning machine of claim 4, wherein RFID signal strength is used as an indicator to approximate the location by estimating a distance between machine and at least some of the plurality of tags.

6. The floor cleaning machine of claim 1, wherein the RFID system is operative to receive a transmission indicating RF signals received by the cleaning machine and to identify a location of the cleaning machine by comparing RE information received by the cleaning machine against RE information stored in association with the location identifiers.

7. The floor cleaning machine of claim 6, wherein the RFID system is operative to receive signal information from a wireless telephone carried by the cleaning machine.

8. The floor cleaning machine of claim 7, wherein the RFID system includes components at a location remote from the region where the tags are distributed.

9. A method of operating a portable floor cleaning machine, comprising:
dispersing a plurality of RFID tags throughout a floor field within which the location of the cleaning machine is to be identified;
traversing the flooring field with the cleaning machine during a cleaning operation;
accessing one or more of the RFID tags during said cleaning operation; and
utilizing information received during said accessing to determine the relative position of the cleaning machine based at least in part on said map.

10. The method of claim 9 further comprising:
mapping signals emitted by the REID tags against locations within the floor field to define a map.

11. The method of claim 9 wherein the step of receiving signals emitted by the tags at the cleaning machine includes sequentially receiving signals as the cleaning machine moves in a path through the flooring field and wherein identifying the location of the cleaning machine includes identifying the location arrived at by following a path indicated by the sequentially received signals.

12. A method of floor cleaning machine localization comprising:
mapping signals emitted by a plurality of RFID tags distributed throughout a region of the floor field to define a floor map;
traversing the floor field during a floor cleaning operation; and
accessing one or more RFID tags and the floor map during said traversing to determine a location of the cleaning machine during the cleaning operation.

13. The method of claim 12 further comprising:
receiving a transmission from cleaning machine indicating RF signals received by the cleaning machine and comparing the RF signals received by the cleaning machine against RF signals associated with each location in the floor map of locations and identifying the location of the cleaning machine as the location associated with RF signals most closely matching the RF signals received by the cleaning machine.

14. A method of operating a floor cleaning machine comprising:
cleaning a floor surface by traversing the floor field with the floor cleaning machine,
during said cleaning, accessing a RFID tag; and
utilizing information received during said accessing to determine a position of the cleaning machine within the floor field.

15. The method of claim 14 further comprising:
mapping signals emitted by a plurality of RFID tags and storing a map of locations of said plurality of RFID tags.

16. The method of claim 15 wherein said dispersing includes associating one of the plurality of RFID tags with a floor tile.

17. The method of claim 16 wherein the floor tile is a carpet tile and said one of the plurality of REID tags is secured to the carpet tile.

18. The method of claim 14 wherein said utilizing includes using a controller on the cleaning machine to accesses an electronic map of RFID locations.

19. The method of claim 19 wherein the electronic map is stored on the cleaning machine or stored at a remote location or both.

20. The method of claim 14 further comprising:
periodically updating a map of RFID locations during operation of the cleaning machine.

21. A method of operating a floor cleaning machine comprising:
cleaning a floor surface by traversing the floor field with the floor cleaning machine,
during said cleaning, accessing a plurality of RFID tags; and
utilizing information received during said accessing to determine a floor cleaning machine performance characteristic.

22. The method of claim 21 further comprising:
providing a report of machine operation based on said determined floor cleaning machine performance characteristic.

23. The method of claim 21 further comprising:
during said cleaning, determining a machine operation status and associating said machine operation status with one or more of the plurality of RFID tags.

24. The method of claim 22 wherein the report provides an indication of area cleaned during a cleaning session or machine efficiency or both.
